(19) United States
(12) Patent Application Publication
(10) Pub. No.: US 2004/0031259 A1
(43) Pub. Date: Feb. 19, 2004

(54) Pyrotechinic microthruster based actuator

(76) Inventors: Jean Baricos, Ramonville (FR); Yan Guelou, Muret (FR); Jean-Pierre Gaechter, Rebigue (FR); Daniel Esteve, Saint Agne (FR); Carole Rossi, Tolosan (FR)

Correspondence Address: Blakely Sokoloff Taylor & Zafman, 7th Floor, 12400 Wilshire Boulevard, Los Angeles, CA, 90025, US

(21) Appl. No.: 10/312,647

(22) PCT Filed: Jun. 28, 2001
(86) PCT No.: PCT/FR01/02060

(30) Foreign Application Priority Data
Jun. 30, 2000 (FR) 00/08501

(51) Int. Cl. F02K 9/08

(52) U.S. Cl. 60/224; 60/253

(57) ABSTRACT

The present invention relates to an actuator system comprising: a matrix (100) of pyrotechnic microthrusters; and control means for controlling the respective firing of said microthrusters (100), and being suitable for generating a specific desired effect.

The present invention relates to the field of actuators.

This field has given rise to very abundant literature.

An object of the present invention is to propose an actuator that is capable of presenting a controlled modulatable effect.

In the context of the present invention, this object is achieved by means of a system comprising:

a matrix of pyrotechnic microthrusters; and

control means for controlling the respective firing of said microthrusters, and being suitable for generating a specific desired effect.

According to an advantageous characteristic of the present invention, each thruster comprises a plate which carries an electrical resistor and a pyrotechnic composition disposed in the vicinity of the resistor so that the pyrotechnic composition is initiated when the resistor is heated as a result of an electric current passing therethrough.

The plate is preferably common to all of the microthrusters.

According to another advantageous characteristic of the present invention, the control means is adapted to control a parameter selected from the group comprising: speed, pressure, flow-rate, time, durability over time, temperature, successive impulses possibly offset over time, safety redundancy, repetitive motion.

Other characteristics, objects, and advantages of the present invention appear on reading the following detailed description, and with reference to the accompanying drawings, given by way of non-limiting examples, and in which:

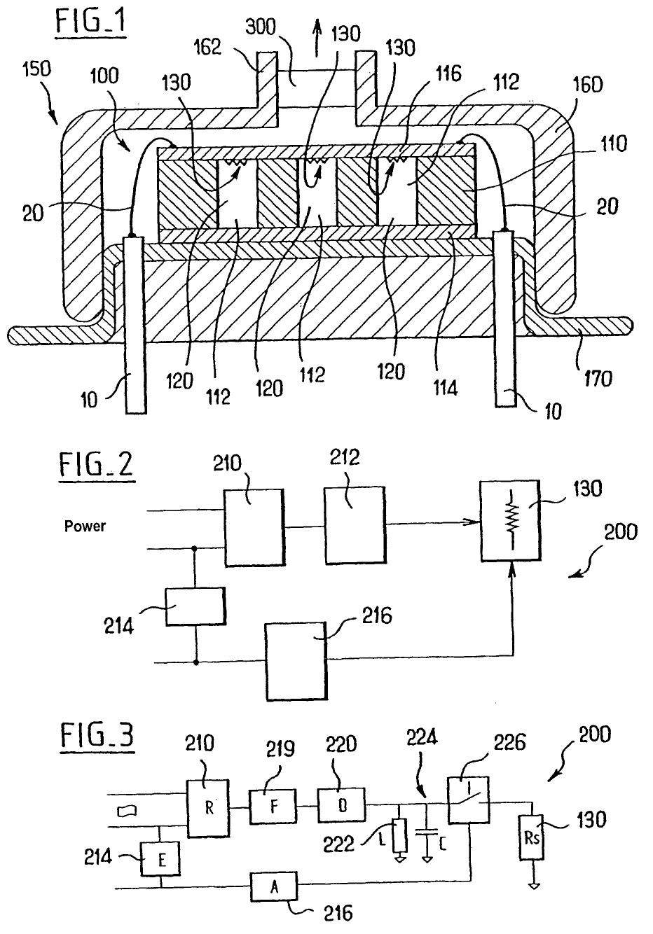

FIG. 1 is a diagrammatic section view of an actuator in accordance with a variant embodiment of the present invention;

FIGS. 2 and 3 are two circuit-diagrams for power-supply devices designed to provide a safety function;

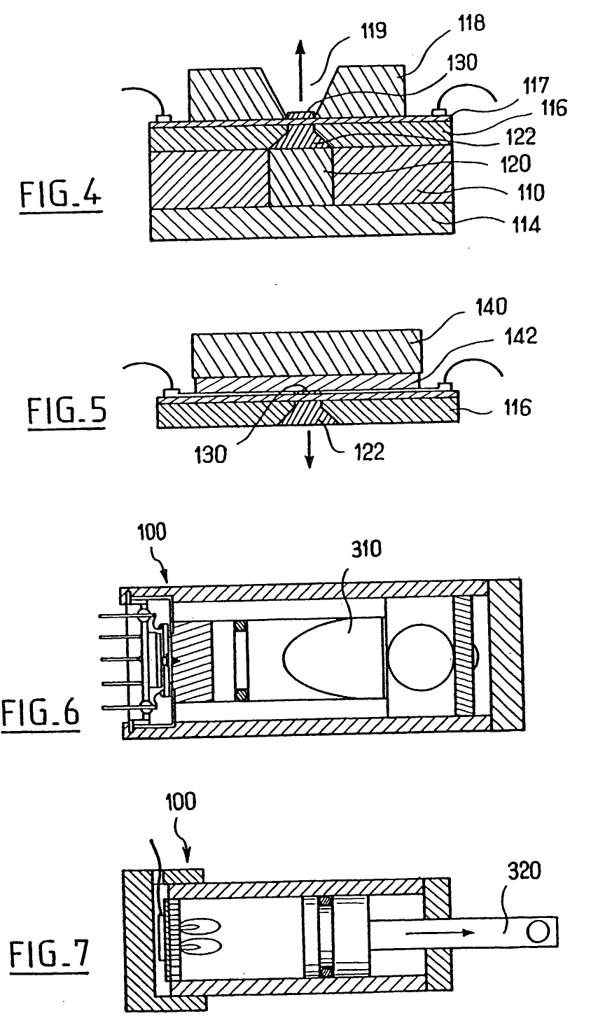

FIGS. 4 and 5 are section views of two variants of thrusters for actuators in accordance with the present invention; and

FIGS. 6 and 7 are section views of systems in accordance with the present invention, respectively forming a cutter member and a jack-type actuator.

The actuator of the present invention comprises a matrix 100 of microthrusters preferably formed by stacking various plates: e.g. an intermediate plate 110 possessing a plurality of parallel wells 112 suitable for containing a pyrotechnic composition 120, a closure plate 114 fixed to the base of the intermediate plate 110 so as to close the bottoms of the wells 112, and a cover plate 116 disposed on top of the intermediate plate 110 to close the second ends of the wells 112.

Wall thickness between the various wells 112 must be sufficient to prevent untimely propagation of the initiation, by a thermal effect, from one well to another.

Naturally, where applicable, one or the other of the two plates 114, 116 can be made integrally with the “intermediate” plate 110.

The cover plate 116 carries a series of resistors 130 each disposed facing a respective one of the wells 112. Over the wells 112, the membrane-forming plate 116 must be sufficiently thin for said plate 116 to be ruptured when the associated composition 120 is fired.

The microthruster matrix 100 is placed in a housing 150. Said housing can be embodied in numerous ways.

In the particular, non-limiting embodiment shown in FIG. 1, the housing 150 is formed by assembling together a cover 160 and a base 170.

The actuator of the present invention further comprises control means for controlling the firing of said microthrusters, and being suitable for generating a specific desired effect, by controlling the successive application of power to the resistors 130.

The control means can be placed outside the housing 150 or inside said housing, e.g. on one of the plates 110, 114, or 116, and preferably on the cover plate 116.

The control means can be embodied in numerous ways, e.g. in the form of an application-specific integrated circuit (ASIC).

To enable each resistor 130 to be fired specifically on request, the resistors 130 must naturally not all be connected in parallel. On the contrary, the resistors 130 must be connected to the control circuit by means of a network of connections enabling each resistor 130 to be specifically addressed with an initiation signal.

The plates 110, 114, and 116 can also be embodied in numerous ways. They are preferably made by machining plates made of silicon or ceramic. Such a technique enables a high-speed mass-production.

The pyrotechnic composition 120 can be embodied in numerous ways. In a preferred embodiment, the composition 120 is made of propellent.

In addition, as can be seen in particular in FIG. 4, where applicable, each thruster can be fitted with a respective primary pyrotechnic composition 122 interposed between the resistor 130 and the associated main composition 120.

The primary composition 122 is preferably placed in a housing formed in the cover plate 116.

The control means is preferably provided with a safety circuit 200 suitable for preventing the untimely supply of power to the resistors 130.

Two embodiments of the safety circuits 200 are shown in FIGS. 2 and 3.

The circuit 200 shown in FIG. 2 comprises a voltage regulator 210 (e.g. a Zener diode) limiting the incident energy, and an HF power supply converter 212 interposed between a power supply and the resistors 130, a limiter 214 disposed between a power supply line and a trigger line fitted with a triggering system 216 which controls the application of a voltage across the resistors 130.

The circuit 200 shown in FIG. 3 comprises, on a power supply line, a voltage regulator 210, e.g. in the form of a Zener diode, a narrow bandpass filter 219 tuned to the modulation of the cocking circuit, a demodulator 220, an energy discharging resistor 222, an energy storage capacity 224, and a switch network 226. The circuit also comprises a limiter 214, and a safe ignition circuit 216 which controls the switch network 226.

The number of thrusters equipping an actuator of the present invention is not limited in any way and can be as great as several hundred.

By controlling the sequence in which the various thrusters are fired, the control means ensures the desired effect, e.g. to cause a parameter such as: speed, pressure, flow-rate, time, durability over time, and temperature, for example, to be maintained at a constant value or to vary in accordance with a predetermined relationship.

The actuator of the present invention can be used in numerous applications.

For example, it can be used to control the inflation of a structure, in particular to inflate it progressively, or else to displace micro tools mechanically, for example, tools such as jacks, pistons, cutter devices, in particular devices for cutting wires or various parts, or even to interrupt an electric current, or another fluid, or to control a valve.

FIG. 1 shows a device comprising a tool carrier 300 mounted to move in translation in a cylinder 162 of the cover 160. The tool carrier 300 is displaced by the gas given off under pressure that results from firing the composition 120, and once the membranes formed in the plate 116 have ruptured.

In a variant, the element 300 corresponding to the moving tool carrier could be fixed securely to the housing 150, the housing 150 then including at least one valve, or else the element 300 could be perforated to form a gas generator.

It should be observed that, in FIG. 1, electrical power supply contacts 10 pass through the base 170 and are connected to the network of connection tracks, or to the control circuit provided on the plate 116, by means of wires 20.

FIG. 4 shows a gas generator actuator comprising a primary composition 122 placed in a converging portion of the cover plate 116 and also comprising an additional plate 118 possessing a diverging portion 119 respectively facing each resistor 130. A SiO₂ plate 117 carrying the resistor 130 is interposed between the plates 118 and 116.

FIG. 5 shows an actuator comprising a base plate 140, e.g. made of ceramic, and an insulating-varnish layer 142 fixed against a plate 116 carrying the resistors 130 facing diverging portions, each housing a pyrotechnic composition 122.

FIG. 6 shows a cutter device comprising a punch 310 guided to move in translation in a housing and actuated by the microactuator matrix 100.

FIG. 7 shows a jack-type device comprising a piston 320 guided to move in translation in a housing and actuated by the microactuator matrix 100.

The control circuit can be controlled under negative feedback by a sensor that is sensitive to the desired parameter, e.g. the pressure, or the displacement stroke, in the case of FIGS. 5 and 6.

In an advantageous variant of the present invention, a safety circuit is respectively associated with each resistor 130, in the vicinity of said resistor, on the silicon support substrate 114.

Naturally, the present invention is not limited to the particular embodiments described above, but extends to any variant within the ambit thereof.

In particular, the present invention enables devices to be made ensuring a redundancy function, i.e. devices that are reliable, compact, lightweight, and that consume only a small amount of energy.

In the ambit of the application to micromechanisms, each thruster of the present invention conventionally possesses dimensions that are smaller than a millimeter.

However, the present invention also applies to pyromechanisms of conventional size in which replacing the igniter with its booster charge by a microthruster plate as described above, makes it possible to provide such a pyromechanism with intelligent operation.

1/ An actuator system comprising:
a matrix (100) of pyrotechnic microthrusters; and
control means for controlling the respective firing of said microthrusters (100), and being suitable for generating a specific desired effect.

2/ A system according to claim 1, characterized by the fact that each thruster (100) comprises a plate (114) which carries an electrical resistor (130) and a pyrotechnic composition (120) disposed in the vicinity of the resistor (130) so that the pyrotechnic composition (120) is initiated when the resistor (130) is heated as a result of an electric current passing therethrough.

3/ A system according to claim 2, characterized by the fact that the plate (114) is common to all of the thrusters (100).

4/ A system according to any one of claims 1 to 3, characterized by the fact that the control means is adapted to control a parameter selected from the group comprising: speed, pressure, flow-rate, time, durability over time, temperature, successive impulses possibly offset over time, safety redundancy, repetitive motion.

5/ A system according to claim 4, characterized by the fact that the control means is designed to maintain the parameter at a constant value.

6/ A system according to claim 4, characterized by the fact that the control means is designed to control the parameter in accordance with a predetermined relationship.

7/ A system according to any one of claims 1 to 6, characterized by the fact that the matrix (100) of microthrusters is formed by stacking various plates: an intermediate plate (110) possessing a plurality of parallel wells (112) suitable for containing a pyrotechnic composition (120), a closure plate (114) fixed to the base of the intermediate plate (110) so as to close the bottoms of the wells (112), and a cover plate (116) disposed on top of the intermediate plate (110) to close the second ends of the wells (112).

8/ A system according to claim 7, characterized by the fact that, over the wells (112), the membrane-forming plate (116) is sufficiently thin for said plate (116) to be ruptured when the associated composition (120) is fired.

9/ A system according to any one of claims 1 to 8, characterized by the fact that the control means is placed on one of the plates (110, 114, or 116) of the microthruster matrix.

10/ A system according to any one of claims 1 to 9, characterized by the fact that the microthruster matrix (100) comprises plates (110, 114, 116) made of silicon or ceramic.

11/ A system according to any one of claims 1 to 10, characterized by the fact that the microthruster matrix (100) comprises a propellent composition (120).

12/ A system according to any one of claims 1 to 11, characterized by the fact that each thruster is fitted with a respective primary pyrotechnic composition (122) interposed between the resistor (130) and the associated main composition (120).

13/ A system according to claim 12, characterized by the fact that the primary composition (122) is placed in a housing formed in a cover plate (116).

14/ A system according to any one of claims 1 to 13, characterized by the fact that the control means is provided with a safety circuit (200) suitable for preventing the untimely supply of power to the resistors (130).

15/ A system according to any one of claims 1 to 14, characterized by the fact that it is used to control the inflation of a structure, in particular to inflate it progressively.

16/ A system according to any one of claims 1 to 14, characterized by the fact that it is used to displace micro tools mechanically, for example, tools such as jacks, pistons, cutter devices, in particular devices for cutting wires or various parts, or even to interrupt an electric current, or another fluid, or to control a valve.

17/ A system according to any one of claims 1 to 16, characterized by the fact that the microthruster matrix (100) is associated with a pyromechanism that is conventional in itself.
